(19) United States
(12) Patent Application Publication
(10) Pub. No.: US 2017/0257679 A1
(43) Pub. Date: Sep. 7, 2017

(54) MULTI-AUDIO ANNOTATION

(71) Applicant: TiVo Solutions Inc., San Carlos, CA (US)

(72) Inventor: Pablo López Zapico, Madrid (ES)

(21) Appl. No.: 15/057,415

(22) Filed: Mar. 1, 2016

(51) Int. Cl. H04N 21/81; H04N 21/233; H04N 21/239; H04N 21/439

(52) U.S. Cl. CPC H04N 21/8106; H04N 21/439; H04N 21/233; H04N 21/2393

(57) ABSTRACT

A first request for a first content stream is received by a media device. In response to receiving the first request, the media device causes video playing of the first content stream. A second request for a second content stream is received by the media device. In response to receiving the second request, the media device causes output of an audio stream from the second content stream in place of an audio stream of the first content stream while the first content stream is being displayed.

### TECHNICAL FIELD

Embodiments relate generally to processing media content by a media device.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Media devices, such as digital video recorders (DVRs), set-top boxes (STBs), portable media devices, etc., receive various types of media content from over-the-air broadcasts, satellite broadcasts, cable channels, etc., and enable users to play, record, and otherwise interact with the media content. In some arrangements, a media device may be configured to receive a media program and play the received program. For example, the media device may be a DVR that can generate an HDMI output for the media program and send the HDMI output to a television for playing to one or more users.

However, a user may be interested in more than one media programs. While a particular media program is being viewed by the user, breaking news may occur, a game changing event may occur in a sports program, etc. When the user realizes existence of such interesting media events, the user may have already missed much of the fun if any still remains. Thus, delays in the time taken for a user to be apprised of and receive other interesting media programs may result in unsatisfactory user experiences.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an example system for processing media content by a media device, in accordance with one or more embodiments;

FIG. 2 is a block diagram illustrating an example media device, in accordance with one or more embodiments;

FIG. 3 is a block diagram illustrating an example multi-audio annotator, in accordance with one or more embodiments;

FIG. 4 illustrates an example process flow, in accordance with one or more embodiments; and

FIG. 5 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
3.0. Example Media Devices
4.0 Example Multi-Audio Annotation Architecture
5.0 User Controls on Multi-Audio Annotation Operations
6.0 Implementation Examples
7.0. Implementation Mechanism-Hardware Overview
8.0. Extensions and Alternatives

### 1.0. General Overview

Approaches, techniques, and mechanisms are disclosed for processing media content by a media device. According to various embodiments, multi-audio annotation operations are described that enables a user to watch video and hear audio from different content streams (e.g., tuner channels accessed by different tuners of a media device, network-based streams via one or more computer networks, Internet-based streams via the Internet, etc.). A number of multi-audio annotation operational scenarios are supported. In an example, while a user watches video from a “Live on TV” tuner channel or content stream, the user can hear news in audio from a different tuner channel or content stream that is of interest to the user. In case of breaking news, the user can monitor it without any time gap. Similarly, a user can be concurrently watching a football game or cartoons and hearing live news being broadcasted on a News channel or content stream. Additionally, optionally, or alternatively, while watching the football game or the cartoons, the user can hear a mixture of both the news and the game's or the cartoons' audio on the same audio speaker or through different audio speakers.

Audio data and video data may be extracted from media data received in content streams (e.g., through multiple tuners, network streaming connections, internet-based streaming connections, etc.) and packaged into an output media content stream or an output media signal. Different portions of audio data (e.g., audio streams, etc.) and video data (e.g., video streams, etc.) derived from different content streams (e.g., tuner channels, network-based streams, internet-based streams, etc.) may be annotated so that user control options can be provided through a user interface to allow a user to control playing of the audio data and the video data. Besides mixing audio content from one content stream and video content from another content stream, other ways of playing audio and video from different content streams can be supported by techniques as described herein. For example, audio content from multiple content streams can be reproduced by different audio speakers of an audio speaker configuration (e.g., headphone, a stereo system, a 5.1 speaker setup, a 7.1 speaker setup, a headphone in addition to an integrated speaker on a client device, etc.). A user may also pause any of audio playing and vide playing related to any of the multiple content streams. The user may adjust audio volume, swap channels for audio and video playing, etc.

Example embodiments described herein relate to multi-audio annotation operations. A first request for a first content stream is received by a media device. In response to receiving the first request, the media device causes video playing of the first content stream. A second request for a second content stream is received by the media device. In response to receiving the second request, the media device causes output of an audio stream from the second content stream in place of an audio stream of the first content stream while the first content stream is being displayed.

In an embodiment, the first content stream represents one of: a first tuner channel accessed through a first tuner of the media device, a first network-based stream accessed via one or more networks, a first internet-based stream accessed via the Internet, etc. The second tuner channel is one of: a second tuner channel accessed through a second tuner of the media device, a second network-based stream accessed via one or more networks, a second internet-based stream accessed via the Internet, etc.

In an embodiment, the media device is further configured to perform: generating and sending a video stream from the first content stream for the video playing on a media rendering device, while concurrently generating and sending the audio stream from the second content stream for audio playing on the same media rendering device.

In an embodiment, the audio stream from the second content stream is rendered on a first audio output channel of the media rendering device; another audio stream generated from the first content stream is concurrently rendered on a second audio output channel of the media rendering device.

In an embodiment, the first audio output channel of the media rendering device and the second audio output channel of the media rendering device are from a single audio output configuration (e.g., headphone, a stereo system, a 5.1 speaker setup, a 7.1 speaker setup, a headphone in addition to an integrated speaker on a client device, etc.) of the media rendering device.

In an embodiment, the media device is further configured to perform: sending a single output content stream (e.g., related to HDMI, 2K resolution, 4K resolution, 8K resolution, MPEG, MPEG 2, MPEG 4, WMV, AVCHD, MOV, H.264, MKV, etc.) that combines a video stream from the first content stream and the audio stream from the second content stream to an external media rendering device.

In an embodiment, the media device is further configured to perform: causing the video playing of the first content stream on a first media rendering device, while concurrently causing rendering the audio stream from the second content stream on a second media rendering device.

In an embodiment, the second media rendering device is an audio-only device.

In an embodiment, the media device is further configured to perform: receiving a third request for swapping content streams; in response to receiving the third request, the media device causing video playing of the second content stream while concurrently causing rendering another audio stream generated from the first content stream.

In an embodiment, the media device is further configured to perform: sending a video stream generated from the second content stream and the other audio stream from the first content stream to a media rendering device in a same output content stream.

In an embodiment, the media device is further configured to perform: in response to receiving the second request, causing, by the media device, not generating the audio stream from the first content stream, while concurrently and continuously generating a video stream from the first content stream.

In an embodiment, the media device is further configured to perform: in response to receiving the second request, causing, by the media device, not generating a video stream from the second content stream, while concurrently and continuously generating the audio stream from the second content stream.

In an embodiment, the media device is further configured to perform: receiving, by the media device, a switch stream request for video playing of the second content stream; in response to receiving the switch stream request, terminating, by the media device, the video playing of the first content stream; switching to cause video playing of the second content stream while concurrently and continuously causing rendering the audio stream from the second content stream.

In an embodiment, the audio stream from the second content stream is rendered concurrently with another audio stream from the first content stream; the media device is further configured to perform: receiving, by the media device, a multi-audio annotation control request that is generated based on user input; in response to receiving the multi-audio annotation control request, performing, by the media device, at least one of: adjusting a volume setting of the audio stream generated from the second content stream, pausing audio playing from the second content stream, adjusting a volume setting of another audio stream generated from the first content stream, pausing audio playing from the first content stream, pausing video playing from the first content stream, etc.

In an embodiment, the media device is further configured to perform: receiving, by the media device, a third request for a third content stream; in response to receiving the third request, causing, by the media device, generating a second audio stream from the third content stream while concurrently and continuously causing the video playing of the first content stream.

In other aspects, the invention encompasses a computer apparatus and a computer-readable medium configured to carry out the foregoing steps.

### 2.0. Structural Overview

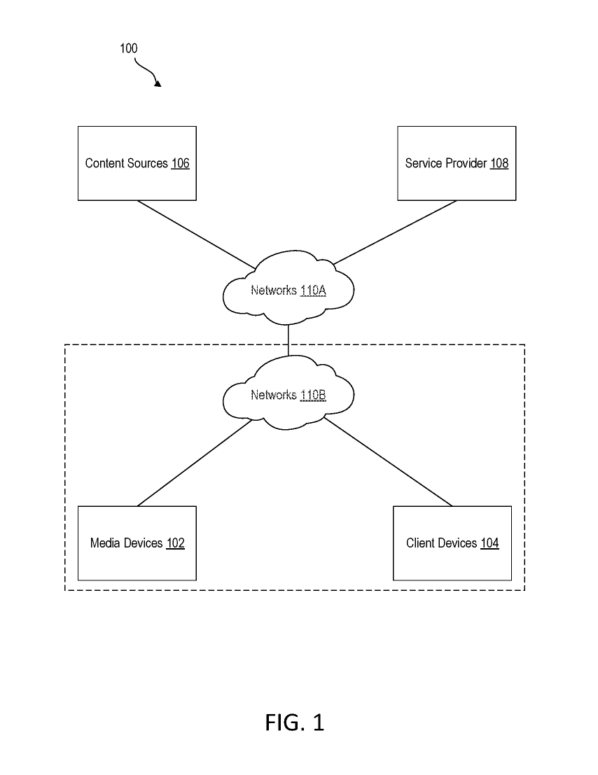

FIG. 1 is an illustrative view of various aspects of an example system 100 in which the techniques described herein may be practiced, according to an embodiment. System 100 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components. Although a specific system is described, other embodiments are applicable to any system that can be used to perform the functionality described herein.

In an embodiment, the system 100 includes one or more media devices (e.g., media device 102), one or more client devices (e.g., client device 104), one or more content sources (e.g., content sources 106), and one or more service providers (e.g., service provider 108). Components of the system 100 may be connected via one or more networks (e.g., networks 110A, 110B). Networks 110A, 110B may be implemented by any medium or mechanism that provides for the exchange of data between components of the system 100. Examples of networks 110A, 110B include, without limitation, a network such as a Local Area Network (LAN), Wide Area Network (WAN), wireless network, the Internet, Intranet, Extranet, etc. Any number of devices within the system 100 may be directly connected to each other through wired or wireless communication segments.

In an embodiment, a media device 102 generally may refer to any type of computing device that is capable of receiving media content items, such as television programs, movies, video on demand (VOD) content, etc., from a cable signal, terrestrial signal, digital network-based data, etc. Examples of media device 102 include, without limitation, a digital video recorder (DVR), media server, set-top box, digital media receiver, etc.

A media device 102 generally may include one or more tuners configured to receive media content from various content sources 106. A tuner may refer to, but is not limited to, any of: a video tuner, an audio tuner, an audiovisual tuner, a CableCARD, a system resource unit, a system component, a signal processing unit, etc. which can be provisioned, tuned, allocated, assigned, used, etc., (e.g., on demand, in advance, etc.) by the media device 102 to receive media content from content sources 106. For example, one content source 106 may include a live television feed. Other example content sources 106 include, but are not limited to, Video On Demand (VOD) libraries, third party content providers (e.g., Netflix® or Amazon Prime®), and web-based media content.

In an embodiment, a client device 104 generally represents any device capable of playing media content. Examples of a client device 104 include, without limitation, digital video recorders (DVR), tablet computers, handheld devices (e.g., cellular phones, etc.), laptops, e-readers, personal computing devices, game devices, etc. In general, client device 104 may refer to any type of computing device that is capable of receiving media content over one or more digital networks 110, such as the public Internet, but which may or may not include a TV-tuner input. A user typically may own several media devices 102 and client devices 104 which may be located at various locations throughout a user's home and elsewhere.

In some embodiments, a media device 102 and a plurality of client devices 104 may be located in multiple rooms of a building such as a home and connected to one or more local area networks (LANs) (e.g., a network 110B). For example, one media device 102 may be located in a user's living room and a client device 104 may be located in another room in the user's house. As one example, a client device 104 may be a tuner-less streaming device that is configured to stream media content from a media device 102 over one or more networks 110B and to play the streamed media content on an output device (e.g., a TV) connected to the client device 104. Media device 102 may receive the media content that is streamed to a client device 104 from one or more media content sources 106.

In one embodiment, a media device 102 may support one or more streaming protocols that allow client devices 104 to access media content over one or more networks 110B. Example streaming protocols include, without limitation, TiVo Multi-Room Streaming (MRS), HTTP Live Streaming (HLS), other standard or proprietary streaming protocols, etc.

In an embodiment, media devices 102 and client devices 104 may communicate with one or more service providers 108 via one or more networks 110A, 110B. A service provider 108 generally may host and otherwise provide access to information such as program guide data, graphical resources (such as fonts, pictures, etc.), service information, software, advertisements, and other data that enables media devices 102 and/or client devices 104 to satisfy user search requests for media content items, generate and display graphical user interfaces, and perform other operations.

System 100 illustrates only one of many possible arrangements of components configured to provide the functionality described herein. Other arrangements may include fewer, additional, or different components, and the division of work between the components may vary depending on the arrangement. Each component of system 100 may feature an open port, API, or other suitable communication interface by which the component may become communicatively coupled to other components of system 100 as needed to accomplish any of the functions of system 100 described herein.

### 3.0 Example Media Devices

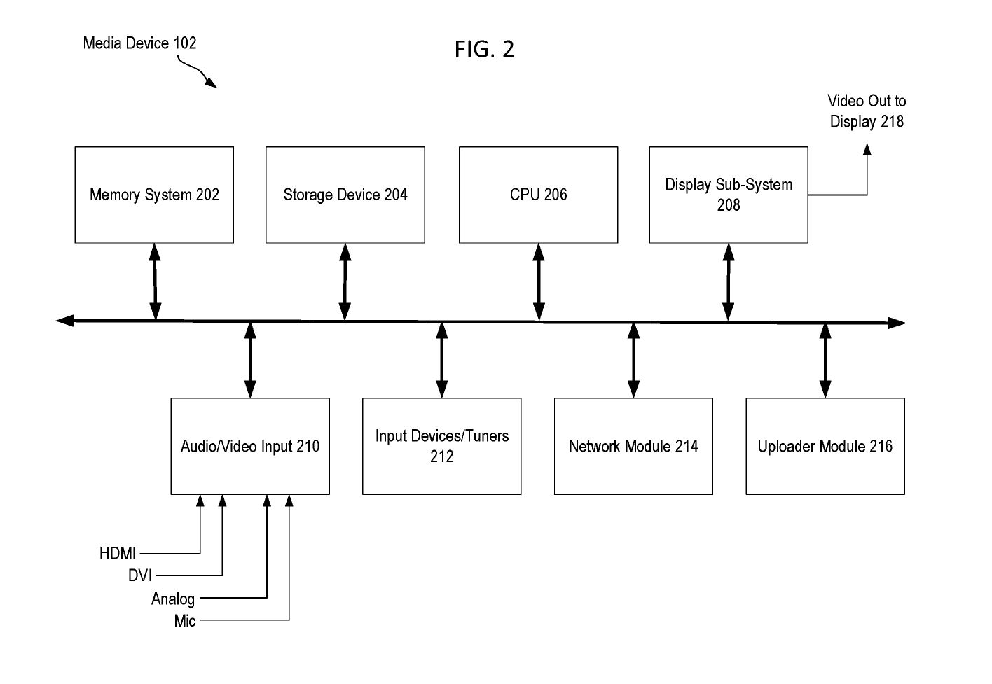

FIG. 2 illustrates an example block diagram of a media device in accordance with one or more embodiments. As shown in FIG. 2, a media device 102 may include multiple components such as a memory system 202, one or more storage devices 204, a central processing unit (CPU) 206, a display sub-system 208, an audio/video input 210, one or more input devices/tuners 212, a network module 214, an uploader module 216, and/or other components used to perform the functionality described herein. In an embodiment, a media device 102 may be a DVR. A multifunction media device is described U.S. patent application Ser. No. 12/631,740, entitled “Multifunction Multimedia Device,” which is owned by the Applicant and is hereby fully incorporated by reference.

In an embodiment, storage devices 204 generally represent secondary storage accessible by the media device 102. A storage device 204 may include, but is not limited to, any combination of, one or more of: Solid State Drives (SSD), hybrid hard drives, hard drives, etc. Each media device 102 may or may not include one or more storage devices 204. If a media device 102 includes a storage device 204, the storage may be used for various purposes including storing all or portions of recorded media content items, providing a buffer for media device tuners 212, pre-caching portions of media content items stored by a cloud storage system, etc.

In an embodiment, audio/video input 210 generally corresponds to any component that includes functionality to receive audio and/or video input (e.g., HDMI, DVI, Analog) from an external source. For example, the audio/video input 210 may be a DisplayPort or a high definition multimedia interface (HDMI) that can receive input from different devices. The audio/video input 210 may receive input from a set-top box, DVR, a Blu-ray disc player, a personal computer, a video game console, an audio/video receiver, a compact disk player, an enhanced versatile disc player, a high definition optical disc, a holographic versatile disc, a laser disc, mini disc, a disc film, a RAM disc, a vinyl disc, a floppy disk, a hard drive disk, etc. A media device 102 may include any number of audio/video inputs 210.

In an embodiment, input device/tuners 212 generally represents any input components that can receive a content stream (e.g., through cable, satellite, internet, network, terrestrial antenna, etc.). In a tuner configuration, input device/tuner 212 may allow one or more received frequencies to pass through while filtering out others (e.g., by using electronic resonance, etc.). A television tuner, for example, may convert an RF television transmission into digital audio and video signals which can be further processed to produce sound and/or an image or accept digital signals such as MPEG2, MPEG4, etc. In an embodiment, each media device 102 may have one or more tuners (e.g., quadrature amplitude modulation (QAM) tuners, Digital Video Broadcasting-Cable (DVB-C) tuners, Advanced Television Systems Committee (ATSC) tuners, etc.) for receiving live or on-demand television content from content sources 106. A tuner can be a physical tuner or a virtual tuner that represents an abstract perception of physical components used to receive broadcast content.

In an embodiment, a network module 214 generally represents any input component that can send and receive data over a network (e.g., internet, intranet, world wide web, etc.). Examples of a network module 214 include, but are not limited to, any of: a network card, network adapter, network interface controller (NIC), network interface card, wireless card, Local Area Network adapter, Ethernet network card, any other component that can send and receive information over a network, such as one or more networks 110A, 110B, etc. The network module 214 may also be used to directly connect with another device (e.g., a media device, a computer, a secondary storage device, etc.).

In an embodiment, an uploader module 216 is configured to manage uploads of media content items from a media device 102 to cloud storage (e.g., storage at an operator headend, service provider system, and/or cloud storage system). In one embodiment, an uploader module 216 includes one or more device efficiency profiles. A device efficiency profile generally represents a set of information that specifies one or more attributes, parameters, and other settings related to how a media device 102 segments and uploads media content items. As indicated above, examples of settings that may be specified in a device efficiency profile include how a media device defines a segment and a frequency with which the media device checks each segment for consistency.

In one embodiment, a media device 102 may switch between device efficiency profiles in response to the occurrence of particular conditions. For example, a media device 102 may be configured to switch profiles if the media device determines that it has received one or more segments containing errors, or if the media device determines that network conditions have changed.

In one embodiment, a media device 102 may be configured to periodically determine and send statistics related to the operation of the media device, including network bandwidth usage, segmentation speed, or any other statistics. The data collected by each media device 102 may be sent and stored by a service provider system. In one embodiment, the service provider system may use the statistical data when selecting particular media devices 102 from which to upload media content segments, to modify or create new device efficiency profiles, or for any other purposes.

In an embodiment, input may be received by a media device 102 from any communicatively coupled device through wired and/or wireless communication segments. Input received by the media device 102 may be stored to the memory system 202 or storage device 204. The memory system 202 may include one or more different types of physical memory to store data. For example, one or more memory buffers (e.g., an HD frame buffer) in the memory system 202 may include storage capacity to load one or more uncompressed high definition (HD) video frames for editing and/or fingerprinting. The memory system 202 may also store frames in a compressed form (e.g., MPEG2, MPEG4, or any other suitable format), where the frames are then uncompressed into the frame buffer for modification, fingerprinting, replacement, and/or display. The memory system 202 may include FLASH memory, DRAM memory, EEPROM, traditional rotating disk drives, etc.

In an embodiment, central processing unit 206 may include functionality to perform the functions described herein using any input received by the media device 102. For example, the central processing unit 206 may be used to dynamically derive fingerprints from media content frames stored in the memory system 202. The central processing unit 206 may be configured to mark or identify media content or portions of media content based on tags, hash values, fingerprints, time stamp, or other suitable information associated with the media content. The central processing unit 206 may be used to modify media content (e.g., scale a video frame, etc.), analyze media content, decompress media content, compress media content, etc. A video frame (e.g., an HD video frame, 4K frame, etc.) stored in a frame buffer may be modified dynamically by the central processing unit 206 to overlay additional content (e.g., information about the frame, program info, a chat message, system message, web content, pictures, an electronic programming guide, video content, textual content, or any other suitable content) on top of the video frame, manipulate the video frame (e.g., stretching, rotation, shrinking, etc.), or replace the video frame in real time. Accordingly, an electronic programming guide, advertisement information that is dynamically selected, media content information, or any other text/graphics may be written onto a video frame stored in a frame buffer to superimpose the additional content on top of the stored video frame. The central processing unit 206 may be used for processing communication with any of the input and/or output devices associated with the media device 102. For example, a video frame that is dynamically modified in real time may subsequently be transmitted for display. The central processing unit 206 may be used to communicate with other media devices to perform functions related to synchronization, publication of data, etc.

In an embodiment, the display sub-system 208 generally represents any software and/or device that includes functionality to output (e.g., Video Out to Display 218) and/or actually display one or more images. Examples of display devices include a kiosk, a hand held device, a computer screen, a monitor, a television, projector, etc. The display devices may use different types of screens or display technology such as a liquid crystal display, cathode ray tube, a projector, a plasma screen, etc. The output from the media device 102 may be specially for formatted for the type of display device being used, the size of the display device, resolution (e.g., 720i, 720p, 1020i, 1020p, or other suitable resolution), etc. However, some media devices 102 may not have any display output components (e.g., a media device primarily configured to stream media content items to other media devices).

### 4.0 Example Multi-Audio Annotation Architecture

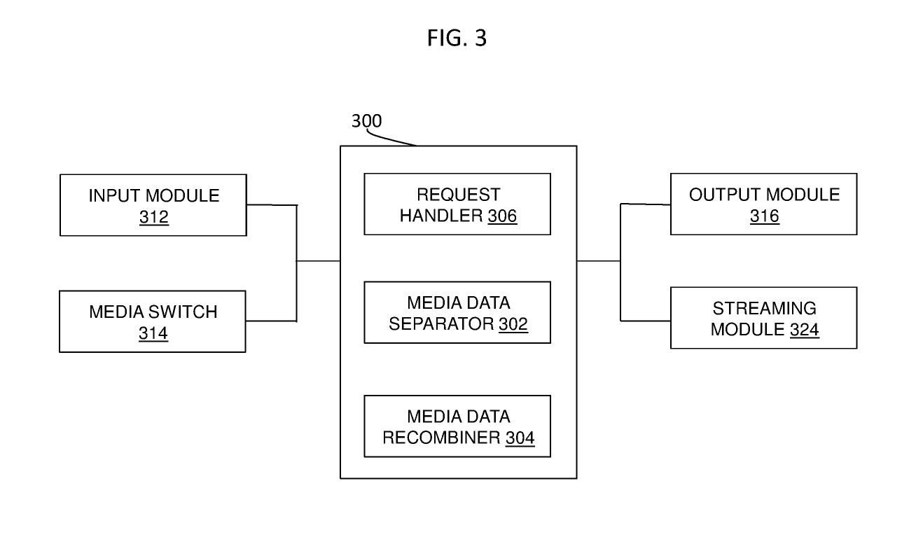

FIG. 3 is a block diagram illustrating an example multi-audio annotator 300, in accordance with one or more embodiments. In FIG. 3, a multi-audio annotator 300 is represented as one or more processing entities collectively configured to receive input media content streams received from a media switch 314, to separate audio data from video data as necessary from the input media content streams, to recombine some or all of the audio data and the video data into output media content streams, to send the output media content streams through one or both of an output module 316 and a streaming module 324 to one or more of client devices, among other features.

In one embodiment, a multi-audio annotator 300 comprises processing entities such as a media content separator 302, a media content recombiner 304, a request handler 306, etc. In an embodiment, a media content separator 302 comprises software, hardware, a combination of software and hardware, etc., configured to receive the input media content streams from media switch 314. The input media content streams from media switch 314 may comprise data from data sources that may include, but are not limited to, any of a tuner, a streaming content server, a URL, a Network Access Storage (NAS), a set top box, a media device, video server, pay per view source, video on demand source, etc. In one embodiment, some of all of the input media content streams from media switch 314 may be derived from one or more input modules (e.g., 312, etc.). In one embodiment, at least one of the input media content streams from media switch 314 as received by media content separator 302 may be derived from one or more storages (e.g., 204 of FIG. 2, etc.). For a given media content stream (e.g., a bitstream, a media content file, a media content container, etc.), media content separator 302 can retrieve data from the media content stream, separate audio data from video data in the data retrieved from the media content stream, etc. As used herein, “separating audio data from video data” refers to generating an audio data portion comprising the audio data and a video data portion comprising the video data. In an embodiment, the audio data portion comprises audio-only data without any video data. In an embodiment, the video data portion comprises video-only data without any audio data.

In an embodiment, a media content recombiner 304 comprises software, hardware, a combination of software and hardware, etc., configured to receive audio data portions and video data portions from media content separator 302. These audio data portions and video portions may be derived from one or more input media content streams from media switch 314. Media content recombiner 304 can select one or more specific audio data portions from among the received audio data portions, select one or more specific video data portions from among the received video data portions, recombine the one or more specific audio data portions and the one or more specific video data portions into an output media content stream and/or an output signal. In an embodiment, at least one of the specific audio data portions and at least one of the specific video data portions are derived (e.g., by media content separator 302, etc.) from two different input media content streams.

In an embodiment, an output media content stream may be annotated by a media device as described herein with annotated stream identification information. As used herein, an annotated (output) media content stream may comprise multi-audio annotation metadata such as the annotated stream identification information, etc. Additionally, optionally, or alternatively, a media device as described herein may maintain annotated stream identification information for an output media content stream, for an output signal, etc. The annotated stream identification information may be used to identify one or more input media content streams as data source(s) for one or more audio or video data portions included in the output media content stream or the output signal.

In an embodiment, a streaming module 324 or an output module 316 sends the output media content stream and/or the output signal to a client device or a media output device (e.g., a digital monitor, a digital television, an analog television, a computer, a smart phone, a tablet, etc.).

In an embodiment, a request handler 306 comprises software, hardware, a combination of software and hardware, etc., configured to receive requests for specific content streams. These requests may be originated based on user input (or user commands) from client devices, from user input devices, etc. that are communicatively coupled with a media device as described herein. Examples of user input devices may include, without limitation, remote controls, keyboards, touch-based user interfaces, pen-based interfaces, graphic user interface displays, pointer devices, etc. In an embodiment, a request for a specific content stream may be received from a client device. In an embodiment, a request for a specific content stream may be received from a user input device that operates in conjunction with the media device. Additionally, optionally, or alternatively, such requests may be received by way of streaming module 324.

A request for a specific content stream may include content stream identification information (e.g., a channel ID, a stream ID, etc.) that can be used to select the specific content stream from among a plurality of content streams accessible to a media device as described herein. The plurality of selectable content streams (e.g., tunable channels, accessible network-based streams, accessible internet-based streams, etc.) may constitute a lineup of all content providers, internet content sources, all channels, etc., accessible by content accessing resources such as tuners, network stream connections, internet stream connections, etc., of the media device for a user of the media device. Additionally, optionally, or alternatively, the request may include position identification information (e.g., a wall clock time, a logical time, a position indicator, etc.) that indicates a position (e.g., a time position, a relative position in reference to a reference position, etc.) within a specific media content stream.

In an embodiment, in response to receiving a request for a specific content stream, request handler 306 may request input module 312 to access the specific content stream through a content accessing resource such as a tuner, a network stream connection, an internet-based stream connection, etc.; to generate/receive the specific media content stream based on media data received from the specific content stream through the content accessing resource; etc. In some embodiments, the specific media content stream may be delivered or provided by input module 312 to media switch 314.

Media switch 314 processes the specific media content stream and sends the (processed) specific media content stream to multi-audio annotator 300, or processing entities therein, for further processing.

In an embodiment, a request for a specific content stream may include request type information (e.g., type indicator, etc.) that indicates a request type for the request, etc. Based on the request type information, the request may be determined by request handler 306 as representing one or more of regular requests, a multi-audio annotation requests of different types, etc.

In a first operational scenario, a user may want to watch video from a specific content stream while listening to audio from the same content stream. The user may provide user input to a user input device to cause a regular request for the specific content stream to be sent to a media device as described herein. In response to receiving the regular request for the specific content stream, request handler 306 may request media switch 314 to forward or switch a specific media content stream that corresponds to the specific content stream to a streaming module 324 or an output module 316. After receiving the specific media content stream, streaming module 324 or output module 316 sends both audio data and video data from the same specific content stream as represented by the specific media content stream to a requesting client device or a media output device (e.g., a digital monitor, a digital television, an analog television, a computer, a smart phone, a tablet, etc.) for which the regular request was generated.

In a second operational scenario, a user may want to watch video from one content stream while listening to audio from a different content stream. In an example, the user may want to watch real time finance data on video from a financial content stream (e.g., CNBC, Bloomberg Business, etc.), while hearing news from a news content stream (e.g., CSPAN, CNN, etc.). In another example, the user may want to watch a football game from a Sports content stream, while listening to news from a news content stream.

The user may provide user input to a user input device to cause a type I multi-audio annotation request for the specific content stream to be sent to a media device as described herein. The type I multi-audio annotation request instructs the media device to keep video from a current content stream the user is watching and to replace audio with the specific content stream identified in the type I multi-audio annotation request.

In response to receiving the type I multi-audio annotation request for the specific content stream, request handler 306 may determine a current content stream the user is watching, request media switch 314 to forward or switch a specific media content stream that corresponds to the specific content stream to media content separator 302, as well as to forward or switch a current media content stream that corresponds to the current content stream to media content separator 302.

After receiving the specific media content stream and the current media content stream, media content separator 302 extracts video data from the current media content stream into a video data portion, extracts audio data from the specific media content stream into an audio data portion, sends/delivers the video data portion of the current content stream and the audio data portion of the specific content stream to media content recombiner 304, etc. The video data portion and the audio data portion may comprise respective content stream identification information annotated by media content separator 302. The respective content stream identification information may be used by a processing entity as described herein to identify which content streams the video data portion and the audio data portion are respectively from.

Upon receiving the video data portion of the current content stream, the audio data portion of the specific content stream, and the respective content stream identification information, media content recombiner 304 combines audio data and video data from the two different content stream as represented by the video data portion of the current content stream and the audio data portion of the specific content stream and causes the combined audio data and video data to be sent to a requesting client device or a media output device (e.g., a digital monitor, a digital television, an analog television, a computer, a smart phone, a tablet, etc.) for which the type I multi-audio annotation request was generated. In an embodiment, the combined audio data and video data may be packaged by media content combiner 304 or streaming module 324 into an output media content stream or an output signal. The output media content stream or the output signal may be sent to the requesting client device or the media output device. The output media content stream or the output signal may comprise annotated content stream identification information used to establish a correspondence relationship between the output media content stream/the output signal and both of the specific content stream and the current content stream.

In a third operational scenario, a user may want to watch video and hear audio from one content stream while listening to audio from a different content stream. For example, initially, the user may be watching the video of the former content stream on a display, while listening to the audio from the former content stream reproduced by a plurality of audio speakers. The user may provide user input to a user input device to cause a type II multi-audio annotation request for the specific content stream to be sent to a media device as described herein. The type II multi-audio annotation request instructs the media device to keep video from a current content stream the user is watching and audio from the current content stream from one or more specific audio speakers in a plurality of audio speakers and to reproduce audio of the specific content stream identified in the type II multi-audio annotation request with one or more other audio speakers in the plurality of audio speakers.

By way of illustration but not limitation, the audio speakers may comprise a pair comprising a right audio speaker and a left audio speaker. The type II multi-audio annotation request may instruct that the right audio speaker to reproduce the audio of the current content stream and that the left audio speaker to reproduce the audio of the specific content stream.

In response to receiving the type II multi-audio annotation request for the specific content stream, request handler 306 may determine a current content stream the user is watching, request media switch 314 to forward or switch a specific media content stream that corresponds to the specific content stream to media content separator 302, as well as to forward or switch a current media content stream that corresponds to the current content stream to media content separator 302.

After receiving the specific media content stream and the current media content stream, media content separator 302 extracts video data from the current media content stream into a video data portion, extracts audio data from the current media content stream into a first audio data portion, extracts audio data from the specific media content stream into a second audio data portion, sends/delivers the video data portion of the current content stream, the first audio data portion of the current content stream, and the second audio data portion of the specific content stream to media content recombiner 304, etc. The video data portion, the first audio data portion and the second audio data portion may comprise respective content stream identification information annotated by media content separator 302. The respective content stream identification information may be used by a processing entity as described herein to identify which content streams the video data portion, the first audio data portion and the second audio data portion are respectively from.

Upon receiving the video data portion of the current content stream, the first audio data portion of the current content stream, the second audio data portion of the specific content stream, and the respective content stream identification information, media content recombiner 304 combines audio data and video data from the two different content stream as represented by the video data portion of the current content stream, the first audio data portion of the current content stream and the second audio data portion of the specific content stream and causes the combined audio data and video data to be sent to a requesting client device or a media output device (e.g., a digital monitor, a digital television, an analog television, a computer, a smart phone, a tablet, etc.) for which the type II multi-audio annotation request was generated.

In an embodiment, the combined audio data and video data may comprise a mixture (e.g., 70/30, 60/40, 50/50, 40/60, 30/70, a user controllable ratio settable by a user with a control option, etc.) of the first audio data portion of the current content stream and the second audio data portion of the specific content stream.

In an embodiment, the combined audio data and video data may comprise right audio channel data derived from the first audio data portion of the current content stream and left audio channel data derived from the second audio data portion of the specific content stream. The right audio channel data and the left audio channel data may be used to drive the right audio speaker and the left audio speaker, respectively. In an embodiment, the right audio channel data represent a mono mix (e.g., generated via audio downmixing) of the audio of the current content stream. In an embodiment, the left audio channel data represent a mono mix (e.g., generated via audio downmixing) of the audio of the specific content stream.

In an embodiment, the combined audio data and video data may be packaged by media content combiner 304 or streaming module 324 into an output media content stream or an output signal. The output media content stream or the output signal may be sent to the requesting client device or the media output device. The output media content stream or the output signal may comprise annotated content stream identification information used to establish a correspondence relationship between the output media content stream/the output signal and both of the specific content stream and the current content stream.

It has been described that a right audio speaker and a left audio speaker can be used to reproduce audio from two different content streams. This is for illustration purposes only. In various embodiments, different speakers and/or different numbers of speakers may be used for reproducing audio from different content streams accessed by content accessing resources as described herein. For example, instead of a right audio speaker, a left audio speaker may be used to reproduce audio from a current content stream. Similarly, instead of a left audio speaker, a right audio speaker may be used to reproduce audio from a specific content stream other than the current content stream. Additionally, optionally, or alternatively, left and right front speakers may be used to reproduce audio from either a current content stream or a specific content stream other than the current content stream. Similarly, left and right surround speakers may be used to reproduce audio from either a current content stream or a specific content stream other than the current content stream. Embodiments include these and other variations of using audio speakers to reproduce audio from different content streams concurrently.

In a fourth operational scenario, a user may want to watch video and hear audio from one content stream while listening to audio from a different content stream. For example, initially, the user may be watching the video and hearing audio of the former content stream with a client device, a media output device, etc. The user may provide user input to a user input device to cause a type III multi-audio annotation request for the specific content stream to be sent to a media device as described herein. The type III multi-audio annotation request instructs the media device to keep video and audio from a current content stream the user is watching on a first device (e.g., a client device, a media output device, etc.) and to reproduce audio of the specific content stream identified in the type III multi-audio annotation request on a second device (e.g., a client device, a media output device, a headphone, etc.). By way of illustration but not limitation, the second device may be operatively linked (e.g., via a wired connection, wirelessly, via Bluetooth, etc.) with the media device and may be configured with media playing capabilities to reproduce at least audio data from an audio signal or an audio content stream.

In response to receiving the type III multi-audio annotation request for the specific content stream, request handler 306 may request media switch 314 to forward or switch a specific media content stream that corresponds to the specific content stream to media content separator 302.

After receiving the specific media content stream, media content separator 302 extracts audio data from the specific media content stream into an audio data portion, sends/delivers the audio data portion of the specific content stream to media content recombiner 304, while the media device continues sending a current media content stream or a current output signal comprising the video and the audio of the current content stream to the first device. The audio data portion may comprise content stream identification information annotated by media content separator 302. The content stream identification information may be used by a processing entity as described herein to identify which content streams the audio data portion are from.

Upon receiving the audio data portion of the specific content stream and the content stream identification information, media content recombiner 304 causes the audio data portion of the specific content stream and optionally the content stream identification information to be sent to the second device.

### 5.0 User Controls on Multi-Audio Annotation Operations

In an embodiment, the audio data portion may be packaged by media content combiner 304 or streaming module 324 into an output audio content stream or an audio output signal. The output audio content stream or the audio output signal may be sent to the second device. The output audio content stream or the audio output signal may comprise annotated content stream identification information used to establish a correspondence relationship between the output media content stream/the output signal and one or both of the specific content stream and the current content stream.

In an embodiment, user controls are provided to a user for controlling multi-annotation operations. These user controls can be implemented in one or more of a variety of ways. In an example, a media device may implement a user interface that allows a user to use one or more of a variety of input devices (e.g., mouse, keyboard, remote control, pen-based user interface, touch-based user interface, voice-based user interface, etc.) to generate user commands for controlling multi-annotation operations. Some or all of the user commands may generate controls, requests, etc., to other devices such as one or more client devices, one or more output devices, etc. In another example, a client device or a media output device may implement a user interface that allows a user to use one or more of a variety of input devices (e.g., mouse, keyboard, remote control, pen-based user interface, touch-based user interface, voice-based user interface, etc.) to generate user commands for controlling multi-annotation operations. Some or all of the user commands may generate controls, requests, etc., to other devices such as the media device, one or more other client devices, one or more other output devices, etc. In yet another example, a high-end remote control may implement a user interface that allows a user to use one or more of a variety of input devices (e.g., mouse, keyboard, remote control, pen-based user interface, touch-based user interface, voice-based user interface, etc.) to generate user commands for controlling multi-annotation operations. Some or all of the user commands may generate controls, requests, etc., to other devices such as the media device, one or more client devices, one or more output devices, etc. Different devices in a multi-audio annotation related system configuration may implement a uniform user interface, or different user interfaces.

A user interface as described herein may have different control options (e.g., menu options, popups, toolboxes, etc.) for a user to select. Upon a user selection of a control option, a user command that corresponds to the selected control option, among the different control options provided by the user interface, may be generated and received by the media device or one or more processing entities therein, which may proceed to perform the requested operation as instructed by the user command. Examples of multi-audio annotation operations, multi-audio annotation user commands, multi-audio annotation control options, etc., may include, but are not necessarily limited to only, multi-audio annotation requests of different types as described herein.

Under techniques as described herein, a single media device such as a DVR, a set-top box, a streaming device, etc., can be controlled (via one or more user interfaces implemented by the media device, a client device, a media output device, a remote control, etc.) by a user to allow the user to access programming or media content in two or more different content streams accessed by two or more different content accessing resources of the single media device. Thus, for example, a user can watch a football game on one content stream, while hearing audio content of another football game on a different content stream; a user can watch a game on one content stream, while hearing music from a different content stream; and so on.

In some operational scenarios, a user watches video content on a first content stream and hear audio content on two or more different content streams. In an embodiment, the two or more different content streams includes the first content stream or one or more second content streams. The audio content from the two or more different content streams may be reproduced by audio speakers which emit sounds to the user in different sound propagation mechanisms (e.g., without headset phones, with headset phones, etc.), from different spatial directions (e.g., center front, left front, right front, left surround, right surround, etc.), etc. The different sound propagation mechanisms, the different spatial directions, etc., provide perceptual cues to the user to concurrently comprehend/enjoy the audio content from the two or more different content streams.

In an embodiment, a user can select media control options provided through a user interface to control audio and video playing related to any content stream (among multiple content streams that are providing audio and video content in multi-audio annotation operations as described herein). For example, the user can select a content stream from which audio is being presently played (by a client device, a media output device, etc.) with a specific audio control option to cause a user command for single content stream audio volume adjustment to be sent to a processing entity such as a request handler 306 of a media device. The user command may carry a specific audio volume setting (in absolute term, in relative term, etc.). In response to receiving the user command for single content stream audio volume adjustment, request handler 306 instructs one (or more) of a media content separator 302, a media content recombiner 304, a streaming module 324, an output module 316, etc., to perform volume adjustment on audio content of the content stream based on the specific audio volume setting. The audio content of the content stream with its volume properly adjusted can be provided to or generated by streaming module 324, output module 316, etc., and send to a client device, a media output device, etc., in a media content stream, in an output signal, etc., using the same signal path as used before the volume change. As a result, the audio content of the content stream with the user selected volume is reproduced from the same audio speakers as used before the volume change.

In an embodiment, a user can select two or more content streams from which audios are being presently played (by one or more client devices, one or more media output devices, etc.) with a specific audio control option to cause a user command for multiple content stream audio volume adjustment to be sent to a processing entity such as a request handler 306 of a media device.

The user command may carry one or more specific audio volume settings (in absolute term, in relative term, etc.). In an example, the one or more specific audio volume settings may represent the same scaling factor for volumes of the audio content in the two or more content streams. In another example, the one or more specific audio volume settings may represent different scaling factors for volumes of the audio content in the two or more content streams. In yet another example, the one or more specific audio volume settings may represent enhancement of an audio volume for one of the two or more content streams and suppression of all other audio volumes for all other content streams in the two or more content streams.

In response to receiving the user command for multiple content stream audio volume adjustment, request handler 306 instructs one (or more) of a media content separator 302, a media content recombiner 304, a streaming module 324, an output module 316, etc., to perform volume adjustment on audio content of the two or more content streams based on the one or more specific audio volume settings. The audio content of the two or more content streams with their volume properly adjusted can be provided to or generated by streaming module 324, output module 316, etc., and send to a client device, a media output device, etc., in one or more media content streams, in one or more output signals, etc., using the same signal path as used before the volume change. As a result, the audio content of the two or more content streams with the user selected volumes is reproduced from the same audio speakers as used before the volume change.

In an embodiment, a user can select media control options on a user interface to control audio and video playing related to any content stream (among multiple content streams that are providing audio and video content in multi-audio annotation operations as described herein). For example, the user can select a content stream from which audio is being presently played (by a client device, a media output device, etc.) with a specific audio control option to cause a user command for pausing single content stream audio to be sent to a processing entity such as a request handler 306 of a media device. The user command identifies the content stream for which audio playing is to be paused. In response to receiving the user command for pausing single content stream audio, request handler 306 instructs one (or more) of a media content separator 302, a media content recombiner 304, a streaming module 324, an output module 316, etc., to generate/modify one or more media content streams, one or more output signals, etc., to cause one or more client devices, one or more media output devices, etc., to pause audio playing from the content stream.

In an embodiment, a user can select two or more content streams from which audios are being presently played (by one or more client devices, one or more media output devices, etc.) with a specific audio control option to cause a user command for pausing multiple content stream audio to be sent to a processing entity such as a request handler 306 of a media device. The user command identifies the two or more content streams for which audio playing is to be paused. In response to receiving the user command for pausing multiple content stream audio, request handler 306 instructs one (or more) of a media content separator 302, a media content recombiner 304, a streaming module 324, an output module 316, etc., to generate/modify one or more media content streams, one or more output signals, etc., to cause one or more client devices, one or more media output devices, etc., to pause audio playing from the two or more content streams.

In an embodiment, a user can select a content stream from which video is being presently played (by a client device, a media output device, etc.) with a specific video control option to cause a user command for pausing single content stream video to be sent to a processing entity such as a request handler 306 of a media device. The user command identifies the content stream for which video playing is to be paused. In response to receiving the user command for pausing single content stream video, request handler 306 instructs one (or more) of a media content separator 302, a media content recombiner 304, a streaming module 324, an output module 316, etc., to generate/modify a media content stream, an output signal, etc., to cause a client device, a media output device, etc., to pause video playing from the content stream.

In an embodiment, a user can select a content stream from which video is being presently played (by a client device, a media output device, etc.) and one or more content streams from which audios are being presently played (by one or more client devices, one or more media output devices, etc.) with a specific media control option to cause a user command for pausing media playing to be sent to a processing entity such as a request handler 306 of a media device. The user command identifies some or all of the two content streams for which audio and video playing is to be paused. In response to receiving the user command for pausing media playing, request handler 306 instructs one (or more) of a media content separator 302, a media content recombiner 304, a streaming module 324, an output module 316, etc., to generate/modify one or more media content streams, one or more output signals, etc., to cause one or more client devices, one or more media output devices, etc., to pause audio and video playing from some or all of the content streams for which audio and video playing is to be paused.

In an embodiment, a user can select media control options provided through a user interface to control multi-audio annotation operations. For example, the user may be watching audio and video from the same content stream with a client device (or a media device, etc.). The user can select a specific content stream with a multi-audio annotation control option to request (e.g., via a type IV multi-audio annotation request) that audio from the specific content stream is to be concurrently played with the video from the former content stream on the client device, whereas audio playing from the former content stream is terminated on the client device. After a while watching video on the former content stream and hearing audio on the specific content stream, the user can optionally select a multi-audio annotation control option to request that audio and video playing be swapped between the former content stream and the specific content stream.

In response to receiving a type IV multi-audio annotation request for the specific content stream, request handler 306 may instruct/coordinate other processing entities to carry out the audio and video swapping operation as requested by the user. In an embodiment, media content separator 302 extracts video data from a first media content stream for the specific content stream into a video data portion, extracts audio data from a second media content stream for the former content stream into an audio data portion, sends/delivers the video data portion of the specific content stream and the audio data portion of the former content stream to media content recombiner 304, etc. The video data portion and the audio data portion may comprise respective content stream identification information annotated by media content separator 302. The respective content stream identification information may be used by a processing entity as described herein to identify which content streams the video data portion and the audio data portion are respectively from.

Upon receiving the video data portion of the specific content stream, the audio data portion of the former content stream, and the respective content stream identification information, media content recombiner 304 combines audio data and video data from the two different content stream as represented by the video data portion of the specific content stream and the audio data portion of the former content stream and causes the combined audio data and video data to be sent to the client device (or a media output device, etc.) for which the type IV multi-audio annotation request was generated. In an embodiment, the combined audio data and video data may be packaged by media content combiner 304 or streaming module 324 into an output media content stream or an output signal. The output media content stream or the output signal may be sent to the client device (or the media output device, etc.). The output media content stream or the output signal may comprise annotated content stream identification information used to establish a correspondence relationship between the output media content stream/the output signal and both of the specific content stream and the current content stream. The client device may proceed to decode audio and video from the received media content stream and render/display the video from the specific content stream and render/reproduce the audio from the former content stream.

### 6.0 Implementation Examples

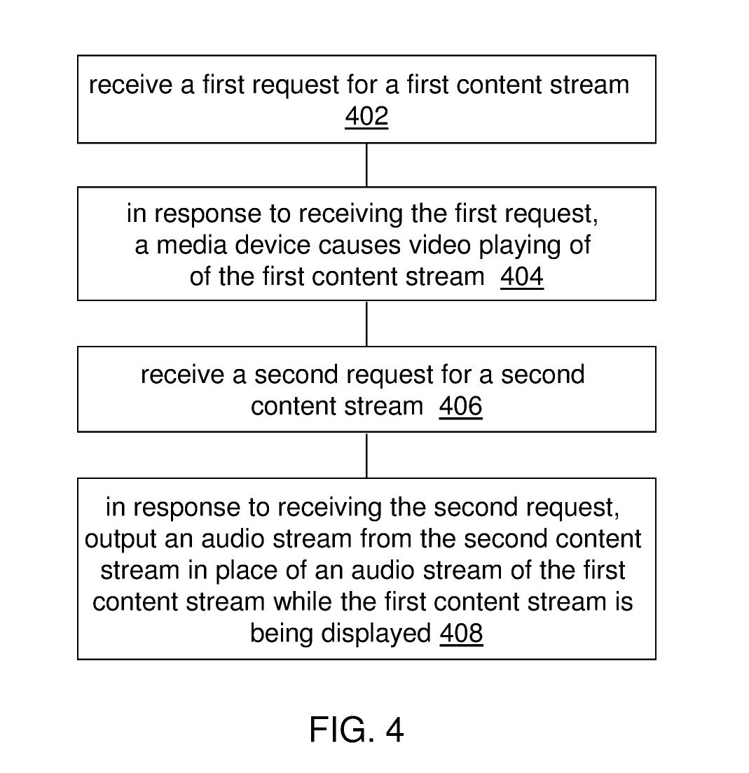

FIG. 4 illustrates an example process flow for multi-audio annotation operations in accordance with one or more embodiments. The various elements may be performed in a variety of systems, including systems such as system 100 described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer. Steps shown in FIG. 4 may be rearranged or omitted. Furthermore, additional steps not shown in FIG. 4 may be performed in accordance with one or more embodiments. Accordingly, the selection or arrangement of steps shown in FIG. 4 should not be construed as limiting.

In block 402, a media device receives a first request for a first content stream.

In block 404, in response to receiving the first request, the media device causes video playing of the first content stream.

In block 406, the media device receives a second request for a second content stream.

In block 408, in response to receiving the second request, the media device causes output of an audio stream from the second content stream in place of an audio stream of the first content stream while the first content stream is being displayed (e.g., being video played, etc.).

In an embodiment, the first content stream represents one of: a first tuner channel accessed through a first tuner of the media device, a first network-based stream accessed via one or more networks, a first internet-based stream accessed via the Internet, etc.; the second tuner channel is one of: a second tuner channel accessed through a second tuner of the media device, a second network-based stream accessed via one or more networks, a second internet-based stream accessed via the Internet, etc.

In an embodiment, the media device is further configured to perform: generating and sending a video stream from the first content stream for the video playing on a media rendering device, while concurrently generating and sending the audio stream from the second content stream for audio playing on the same media rendering device.

In an embodiment, the audio stream from the second content stream is rendered on a first audio output channel of the media rendering device; another audio stream generated from the first content stream is concurrently rendered on a second audio output channel of the media rendering device.

In an embodiment, the first audio output channel of the media rendering device and the second audio output channel of the media rendering device are from a single audio output configuration of the media rendering device.

In an embodiment, the media device is further configured to perform: sending a single output content stream that combines a video stream from the first content stream and the audio stream from the second content stream to an external media rendering device.

In an embodiment, the media device is further configured to perform: causing the video playing of the first content stream on a first media rendering device, while concurrently causing rendering the audio stream from the second content stream on a second media rendering device.

In an embodiment, the second media rendering device is an audio-only device.

In an embodiment, the media device is further configured to perform: receiving a third request for swapping content streams; in response to receiving the third request, the media device causing video playing of the second content stream while concurrently causing rendering another audio stream generated from the first content stream.

In an embodiment, the media device is further configured to perform: sending a video stream generated from the second content stream and the other audio stream from the first content stream to a media rendering device in a same output content stream.

In an embodiment, the media device is further configured to perform: in response to receiving the second request, causing, by the media device, not generating the audio stream from the first content stream, while concurrently and continuously generating a video stream from the first content stream.

In an embodiment, the media device is further configured to perform: in response to receiving the second request, causing, by the media device, not generating a video stream from the second content stream, while concurrently and continuously generating the audio stream from the second content stream.

In an embodiment, the media device is further configured to perform: receiving, by the media device, a switch stream request for video playing of the second content stream; in response to receiving the switch stream request, terminating, by the media device, the video playing of the first content stream; switching to cause video playing of the second content stream while concurrently and continuously causing rendering the audio stream from the second content stream.

In an embodiment, the audio stream from the second content stream is rendered concurrently with another audio stream from the first content stream; the media device is further configured to perform: receiving, by the media device, a multi-audio annotation control request that is generated based on user input; in response to receiving the multi-audio annotation control request, performing, by the media device, at least one of: adjusting a volume setting of the audio stream generated from the second content stream, pausing audio playing from the second content stream, adjusting a volume setting of another audio stream generated from the first content stream, pausing audio playing from the first content stream, pausing video playing from the first content stream, etc.

In an embodiment, the media device is further configured to perform: receiving, by the media device, a third request for a third content stream; in response to receiving the third request, causing, by the media device, generating a second audio stream from the third content stream while concurrently and continuously causing the video playing of the first content stream.

### 7.0 Implementation Mechanism-Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

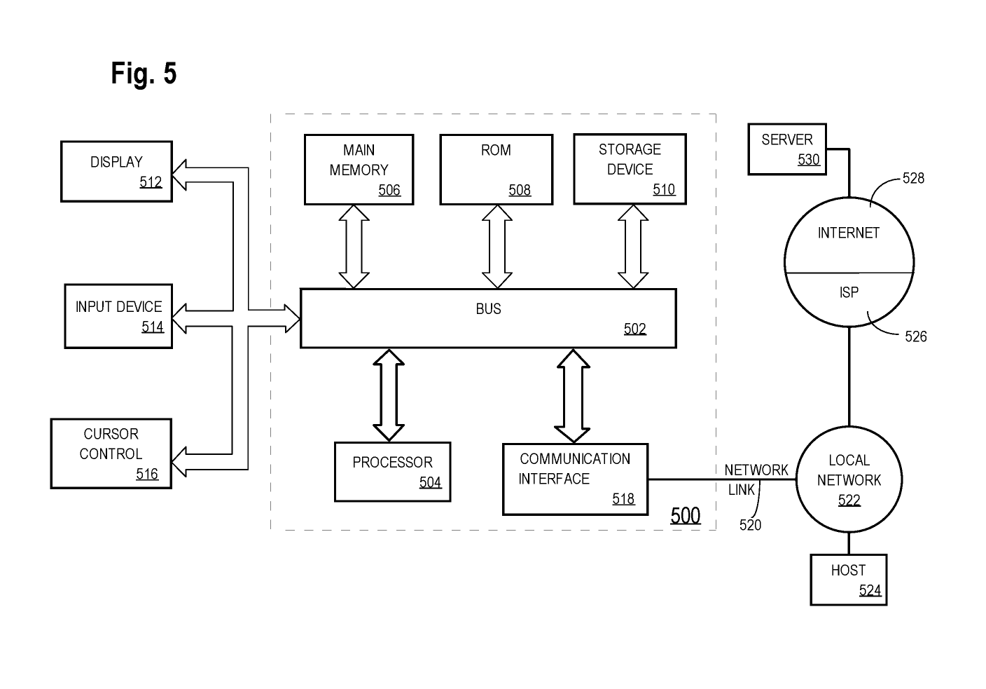

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, flash disk, etc., is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In an embodiment, some or all of the systems described herein may be or comprise server computer systems, including one or more server computer devices that collectively implement various components of the system as a set of server-side processes. The server computer systems may include web server, application server, database server, and/or other conventional server components that the depicted components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third third-party entities, on behalf of another entity for whom the components are deployed. In other embodiments, however, the described systems may be implemented entirely by computer systems owned and operated by a single entity.

### 8.0 Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving, by a media device, a first request for a first content stream;
in response to receiving the first request, causing, by the media device, video playing of the first content stream;
receiving, by the media device, a second request for a second content stream;
in response to receiving the second request, causing, by the media device, output of an audio stream from the second content stream in place of an audio stream of the first content stream while the first content stream is being displayed.

2. The method as recited in claim 1, wherein the first content stream represents one of: a first tuner channel accessed through a first tuner of the media device or a first network-based stream accessed via one or more networks; and wherein the second tuner channel is one of: a second tuner channel accessed through a second tuner of the media device or a second network-based stream accessed via one or more networks.

3. The method as recited in claim 1, further comprising: generating and sending, by the media device, a video stream from the first content stream for the video playing on a media rendering device, while concurrently generating and sending, by the media device, the audio stream from the second content stream for audio playing on the same media rendering device.

4. The method as recited in claim 3, wherein the audio stream from the second content stream is rendered on a first audio output channel of the media rendering device; and wherein another audio stream generated from the first content stream is concurrently rendered on a second audio output channel of the media rendering device.

5. The method as recited in claim 4, wherein the first audio output channel of the media rendering device and the second audio output channel of the media rendering device are from a single audio output configuration of the media rendering device.

6. The method as recited in claim 1, further comprising: sending, by the media device, a single output content stream that combines a video stream from the first content stream and the audio stream from the second content stream to an external media rendering device.

7. The method as recited in claim 1, further comprising: causing, by the media device, the video playing of the first content stream on a first media rendering device, while concurrently causing, by the media device, rendering the audio stream from the second content stream on a second media rendering device.

8. The method as recited in claim 7, wherein the second media rendering device is an audio-only device.

9. The method as recited in claim 1, further comprising:
receiving, by the media device, a third request for swapping content streams;
in response to receiving the third request, the media device causing video playing of the second content stream while concurrently causing rendering another audio stream generated from the first content stream.

10. The method as recited in claim 9, further comprising: sending, by the media device, a video stream generated from the second content stream and the other audio stream from the first content stream to a media rendering device in a same output content stream.

11. The method as recited in claim 1, further comprising: in response to receiving the second request, causing, by the media device, not generating the audio stream from the first content stream, while concurrently and continuously generating a video stream from the first content stream.

12. The method as recited in claim 1, further comprising: in response to receiving the second request, causing, by the media device, not generating a video stream from the second content stream, while concurrently and continuously generating the audio stream from the second content stream.

13. The method as recited in claim 1, further comprising:
receiving, by the media device, a switch stream request for video playing of the second content stream;
in response to receiving the switch stream request,
terminating, by the media device, the video playing of the first content stream;
switching to cause video playing of the second content stream while concurrently and continuously causing rendering the audio stream from the second content stream.

14. The method as recited in claim 1, wherein the audio stream from the second content stream is rendered concurrently with another audio stream from the first content stream; further comprising:
receiving, by the media device, a multi-audio annotation control request that is generated based on user input;
in response to receiving the multi-audio annotation control request, performing, by the media device, at least one of: adjusting a volume setting of the audio stream generated from the second content stream, pausing audio playing from the second content stream, adjusting a volume setting of another audio stream generated from the first content stream, pausing audio playing from the first content stream, or pausing video playing from the first content stream.

15. The method as recited in claim 1, further comprising:
receiving, by the media device, a third request for a third content stream;
in response to receiving the third request, causing, by the media device, generating a second audio stream from the third content stream while concurrently and continuously causing the video playing of the first content stream.

16. A non-transitory computer readable medium storing a program of instructions that is executable by a device to perform:
receiving, by a media device, a first request for a first content stream;
in response to receiving the first request, causing, by the media device, video playing of the first content stream;
receiving, by the media device, a second request for a second content stream;
in response to receiving the second request, causing, by the media device, output of an audio stream from the second content stream in place of an audio stream of the first content stream while the first content stream is being displayed.

17. The medium as recited in claim 16, wherein the first content stream represents one of: a first tuner channel accessed through a first tuner of the media device or a first network-based stream accessed via one or more networks; and wherein the second tuner channel is one of: a second tuner channel accessed through a second tuner of the media device or a second network-based stream accessed via one or more networks.

18. The medium as recited in claim 16, wherein the program of instructions further comprises instructions that are executable by the device to perform: generating and sending, by the media device, a video stream from the first content stream for the video playing on a media rendering device, while concurrently generating and sending, by the media device, the audio stream from the second content stream for audio playing on the same media rendering device.

19. The medium as recited in claim 16, wherein the program of instructions further comprises instructions that are executable by the device to perform: sending, by the media device, a single output content stream that combines a video stream from the first content stream and the audio stream from the second content stream to an external media rendering device.

20. The medium as recited in claim 16, wherein the program of instructions further comprises instructions that are executable by the device to perform: causing, by the media device, the video playing of the first content stream on a first media rendering device, while concurrently causing, by the media device, rendering the audio stream from the second content stream on a second media rendering device.

21. An apparatus comprising a processor and configured to perform:
receiving, by a media device, a first request for a first content stream;
in response to receiving the first request, causing, by the media device, video playing of the first content stream;
receiving, by the media device, a second request for a second content stream;
in response to receiving the second request, causing, by the media device, output of an audio stream from the second content stream in place of an audio stream of the first content stream while the first content stream is being displayed.

22. The apparatus as recited in claim 21, wherein the first content stream represents one of: a first tuner channel accessed through a first tuner of the media device or a first network-based stream accessed via one or more networks; and wherein the second tuner channel is one of: a second tuner channel accessed through a second tuner of the media device or a second network-based stream accessed via one or more networks.

23. The apparatus as recited in claim 21, wherein the program of instructions further comprises instructions that are executable by the device to perform: generating and sending, by the media device, a video stream from the first content stream for the video playing on a media rendering device, while concurrently generating and sending, by the media device, the audio stream from the second content stream for audio playing on the same media rendering device.

24. The apparatus as recited in claim 21, wherein the apparatus is further configured to perform: sending, by the media device, a single output content stream that combines a video stream from the first content stream and the audio stream from the second content stream to an external media rendering device.

25. The apparatus as recited in claim 21, wherein the apparatus is further configured to perform: causing, by the media device, the video playing of the first content stream on a first media rendering device, while concurrently causing, by the media device, rendering the audio stream from the second content stream on a second media rendering device.
